(19) United States
(12) Patent Application Publication
(10) Pub. No.: US 2017/0129610 A1
(43) Pub. Date: May 11, 2017

(54) STRUCTURE FOR RECEIVING GALLEY UNIT FOR AIRCRAFT

(71) Applicant: JAMCO CORPORATION, Mitaka-shi, Tokyo (JP)

(72) Inventors: Kenji Nojiri, Mitaka-shi (JP); Yoshihisa Tsutsui, Mitaka-shi (JP)

(73) Assignee: JAMCO CORPORATION, Mitaka-shi, Tokyo (JP)

(21) Appl. No.: 15/318,746

(22) PCT Filed: Jul. 4, 2014
(86) PCT No.: PCT/JP2014/067888

§ 371 Date: Dec. 14, 2016

(51) Int. Cl. B64D 11/04; B64C 1/06

(52) U.S. Cl. CPC B64D 11/04; B64C 1/06

(57) ABSTRACT

Provided is a structure for receiving a galley unit for an aircraft, including a receiving space formed above a ceiling of an aircraft body, and a lifting mechanism lifting and lowering a load between the receiving space and a galley body, wherein the galley body includes a work table and a rack mounted to the work table, the lifting mechanism is mounted to the rack, and the lifting mechanism is configured so that a lifting and lowering operation of the load is performed within a projected area of an upper surface of the work table.

### TECHNICAL FIELD

The present invention relates to a structure of a galley unit (or a kitchen unit) installed on a passenger aircraft, and specifically, relates to a storage structure provided in the galley unit.

### BACKGROUND ART

Regarding a galley for an aircraft installed on a passenger aircraft, there are demands to realize saving of space of the galley unit itself, so as to increase the number of seats and increase the number of passengers on the aircraft or to ensure space between the seats in consideration of the ride quality of the passengers.

On the other hand, the increase of passengers leads to the increase of the amount of foods and drinks served on board the aircraft, so that the number of carts for carrying the foods and drinks tends to be increased, and the amount of foods and drinks that must be stocked on the aircraft also tends to be increased.

In order to satisfy these requests within the limited space on board the passenger aircraft, conventionally, there is known a galley unit equipped with a cart lift having a platform on which a cart is mounted and supported, and enabling the carts to be stored in two layers, one above the other (refer for example to Patent Literature 1).

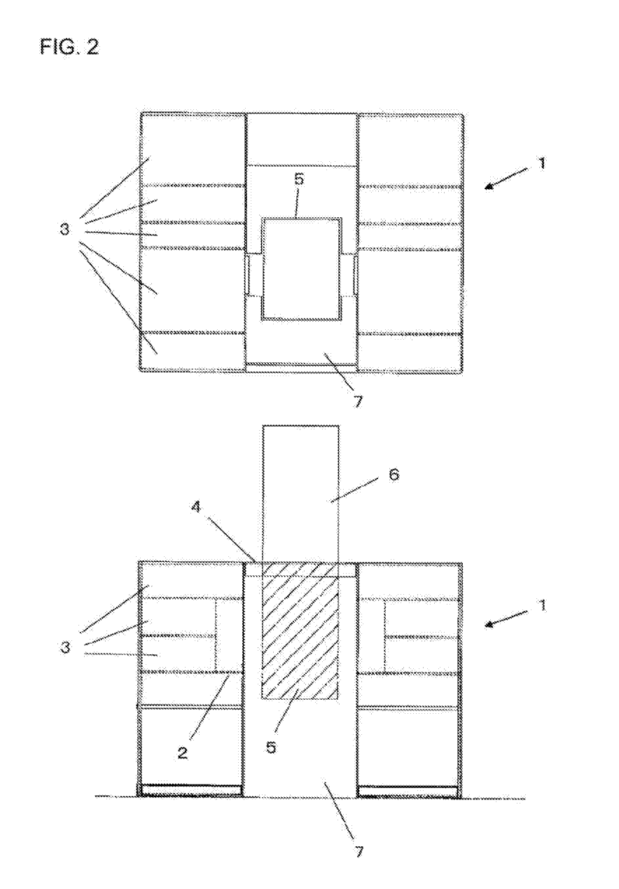

Further, as illustrated in FIG. 2, for example, a storage structure is known where, in a galley unit 1 having a work table 2 and a rack 3 receiving (or storing) storage containers, drink dispensers, ovens and so on, a receiving space (or storing space) 6 equipped with a lifting mechanism 5 is provided on a ceiling 4 of a work area 7 of the crew, wherein by storing spare carts and stocked loads in the receiving space 6, the crew can take or stock objects from/to the structure by operating the lifting mechanism 5 as required.

### CITATION LIST

### Patent Literature

[PTL 1] Japanese Translation of PCT International Application Publication No. JP-T-2010-512269

### SUMMARY OF INVENTION

### Technical Problem

However, the galley unit having the structure disclosed in Patent Literature 1 adopts a two-level structure, which increases the number of carts that can be stored, but on the other hand, requires the space for receiving (or storing) galley components, such as storage containers, drink dispensers and ovens, to be cut down in order to ensure the space for receiving the carts stacked in two levels.

On the other hand, according to the prior art storage structure described above, although it is possible to ensure additional receiving space in the space above the ceiling, but the crew must evacuate from a lifting area of the lifting mechanism or a work area when performing lifting and lowering operation of load, so that there is a drawback that work efficiency is deteriorated.

Therefore, the object of the present invention is to provide a structure for receiving a galley unit for an aircraft capable of ensuring work space and receiving space without deteriorating the work efficiency of the crew.

### SOLUTION TO PROBLEM

In order to solve the problems mentioned above, the present invention provides a structure for receiving a galley unit for an aircraft, including a receiving space formed above a ceiling of an aircraft body, and a lifting mechanism lifting and lowering a load between the receiving space and a galley body, wherein the galley body comprises a work table and a rack mounted to the work table, and the lifting mechanism is configured to perform a lifting and lowering operation of the load within a projected area of an upper surface of the work table.

According to the structure for receiving a galley unit for an aircraft of the present invention, the lifting mechanism can be mounted to the ceiling of the aircraft body. Further, the lifting mechanism can be mounted to a side surface of the rack.

### ADVANTAGEOUS EFFECTS OF INVENTION

According to the structure for receiving a galley unit for an aircraft of the present invention, work space and receiving space can be ensured without having to deteriorate the work efficiency of the crew.

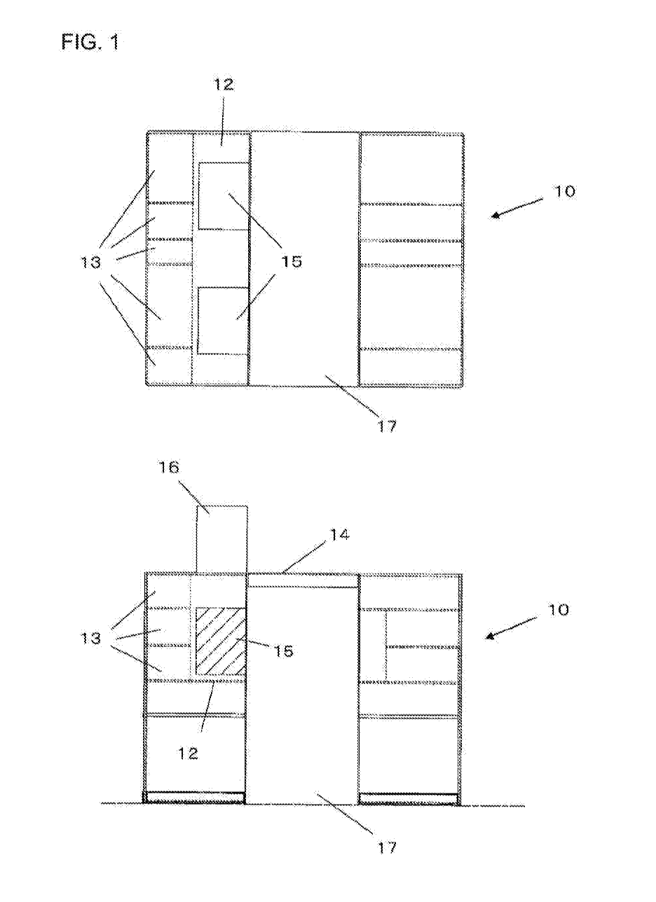

### BRIEF DESCRIPTION OF DRAWINGS

[FIG. 1] FIG. 1 is an upper view and a side view illustrating an outline of a galley unit installed on an aircraft according to the present invention.

[FIG. 2] FIG. 2 is an upper view and a side view illustrating an example of a galley unit installed on an aircraft according to the prior art.

### DESCRIPTION OF EMBODIMENTS

FIG. 1 is an upper view and a side view illustrating an outline of a galley unit installed on an aircraft according to the present invention.

As illustrated in FIG. 1, a galley unit 10 according to the present invention includes a work table 12 on which a crew on board the aircraft prepares for meals and other services, a rack 13 disposed above the work table 12 and receiving (or storing) storage containers, drink dispensers, ovens and so on, a lifting mechanism 15 mounted to a ceiling 14 at a projected area of an upper surface of the work table 12, and a receiving space (or storing space) 16 formed when the lifting mechanism 15 is arranged at a ceiling area above the ceiling 14.

According to the present invention, a “projected area” refers to a space positioned above the work table 12, excluding the portion of the rack 13.

Further, in the ceiling 14, the area corresponding to the portion where the load is lifted and lowered by the lifting mechanism 15 is opened, and as required, a door closing the opening, such as a sliding door, is provided.

According to the structure for receiving (or storing) the galley unit 10 illustrated in FIG. 1, in a case where the crew enters a work area 17 and performs preparations for serving meals, for example, the lifting mechanism 15 positioned above the work table 12 can be lifted and lowered to store or take out load freely from the receiving space 16 formed above the ceiling.

At this time, the lifting mechanism 15 is lifted and lowered in the projected area above the work table 12, so that the crew does not have to evacuate from the work area 17. Therefore, the efficiency of the above-described operation will not be deteriorated by the operation to store or take out the load.

Moreover, since the receiving space 16 above the ceiling is positioned at the projected area, even if an object falls from the receiving space 16 due to failure and the like of the lifting mechanism 15, the object will not fall on the head of the crew working in the work area 17, so that safety will be improved.

According to a specific example of the structure for receiving a galley unit according to the present invention, an example has been illustrated of a case where the lifting mechanism 15 is mounted to the ceiling 14, but it is also possible to adopt a configuration where the lifting mechanism 15 is mounted to a side surface of the rack 13 of the galley unit 10. In that case, it is not necessary to form the galley unit 10 and the ceiling 14 having the lifting mechanism 15 separately.

Further, a specific example including a door for closing the opening through which the lifting mechanism 15 enters and exists the ceiling 14 has been illustrated, but it is also possible to adopt a configuration where a load mounting means of the lifting mechanism 15 is formed as a substitute means of the door. In that case, it is possible to omit the operation of opening and closing the door when the crew operates the lifting unit 15.

Further, an example of a case where the work table 12 is formed across the whole width of the galley unit 10 has been illustrated in the above-described specific example, but it is also possible to form the work table 12 to cover only the area corresponding to the receiving space 16. In that case, the receiving capacity of the rack 13 can be increased, so that a layout can be selected freely according to whether it is necessary to ensure the width of the work table or to ensure the receiving capacity of the rack.

According further to the above-described embodiment, an example has been illustrated of a case where two lifting units 15 are provided, but according to the present invention, an arbitrary number of elevating units can be provided.

### REFERENCE SIGNS LIST

10 Galley unit
12 Work table
13 Rack
14 Ceiling
15 Lifting mechanism
16 Receiving space
17 Work area

1. A structure for receiving a galley unit for an aircraft, comprising:
a receiving space formed above a ceiling of an aircraft body; and
a lifting mechanism lifting and lowering a load between the receiving space and a galley body,
wherein the galley body comprises a work table and a rack mounted to the work table, and
the lifting mechanism is configured so that a lifting and lowering operation of the load is performed within a projected area of an upper surface of the work table.

2. The structure for receiving a galley unit for an aircraft according to claim 1, wherein the lifting mechanism is mounted to the ceiling of the aircraft body.

3. The structure for receiving a galley unit for an aircraft according to claim 1, wherein the lifting mechanism is mounted to a side surface of the rack.
